(19) United States
(12) Patent Application Publication
(10) Pub. No.: US 2026/0214123 A1
(43) Pub. Date: Jul. 23, 2026

(54) GENERATING APPLICATION TAGS TO CONFIGURE MANAGED NETWORK DEVICES TO IDENTIFY NETWORK TRAFFIC FLOWS

(71) Applicant: HEWLETT PACKARD ENTERPRISE DEVELOPMENT LP, Spring, TX (US)

(72) Inventors: Samuel Pérez Buñuel, Santa Clara, CA (US); Ponnu Velu Arumugam, Fremont, CA (US); Aniketh Chincholkar, Santa Clara, CA (US); Christella Jone James Arulraj, Santa Clara, CA (US); Manu Vij, Santa Clara, CA (US); Goutham Damalcheruvu, Santa Clara, CA (US); Bhagvan Cheeyandira, Santa Clara, CA (US); Naresh K. Singh, Santa Clara, CA (US)

(21) Appl. No.: 19/034,156

(22) Filed: Jan. 22, 2025

(51) Int. Cl. H04L 9/40

(52) U.S. Cl. CPC H04L 63/20; H04L 63/0236; H04L 63/104

(57) ABSTRACT

A technique includes receiving application intelligence data representing network traffic flow signatures that are associated with respective applications. The technique includes associating the applications with an application group and generating a tag associated with the application group and including data representing rules to apply to recognize the network traffic flow signatures. The technique includes configuring a managed network device to identify network traffic flows associated with the applications. The configuration includes providing the tag to the managed network device to cause the managed network device to apply the rules to identify the network traffic flows.

### BACKGROUND

Network devices of a computer network may apply various policies to network traffic flows. For example, a network device may apply a security policy that restricts traffic flows based on, among other possible factors, application affiliation. In an example, the network device drops ingress packets that, according to the security policy, are prohibited.

### BRIEF DESCRIPTION OF THE DRAWINGS

FIG. 1 is a block diagram of a computer network that includes a network management system (NMS) cluster that includes an application intelligence engine that generates application tags and distributes the application tags to managed network devices of the NMS cluster, according to an example implementation.

FIG. 2 is an illustration of a mapping of application intelligence supplied by application intelligence vendors to vendor agnostic application tags, according to an example implementation.

FIG. 3 is an illustration of different categories of application tags according to an example implementation.

FIG. 4 is an illustration of an application tag content according to an example implementation.

FIG. 5A is a block diagram of an application intelligence architecture according to an example implementation.

FIG. 5B depicts an enriched telemetry feed for a managed network device according to an example implementation.

FIG. 6 is a flow diagram depicting a technique to determine a normalized application name corresponding to a vendor application identifier according to an example implementation.

FIG. 7 is a flow diagram depicting a technique to determine an application UUID corresponding to a normalized application name according to an example implementation.

FIG. 8 is a flow diagram depicting a technique to create or update an application tag to include one or multiple rules to identify network flows having an application signature provided by application intelligence, according to an example implementation.

FIG. 9 is a flow diagram depicting a technique to generate a tag and configure a managed network device to use the tag to recognize network traffic flow signatures associated with a group of applications, according to an example implementation.

FIG. 10 is an illustration of a non-transitory storage medium that stores instructions that when executed by a hardware processor, cause an NMS engine to generate a tag that includes data representing rules for a managed network device to apply to recognize network traffic flow signatures associated with an application, according to an example implementation.

FIG. 11 is a block diagram of an NMS cluster that includes an application intelligence engine to generate a tag that includes data representing rules for a managed network device to apply to recognize network traffic flow signatures associated with a group of applications, according to an example implementation.

### DETAILED DESCRIPTION

A network management system (NMS) cluster provides centralized NMS services that monitor, update and manage a deployment of managed network devices, as well as troubleshoot and predict issues with the managed network devices. A managed network device may apply one or multiple application-centric policies (e.g., security, routing and Quality-of-Service (QoS) policies) to incoming, or ingress, network traffic flows that are received by the device. For this purpose, the managed network device associates ingress network traffic flows with applications and applies the policies corresponding to the applications. For example, in accordance with a particular security policy, a managed network device may deny network traffic flows associated with Application A; and permit network traffic flows associated with Applications B and C. In another example, in accordance with a QoS policy, a managed network device may allocate more bandwidth for network traffic flows associated with Application B, as compared to the bandwidth that the managed network device allocates for network traffic flows associated with Application C. The applicability of a policy to a network traffic flow may also depend on the destination and source roles associated with the network traffic flow.

A managed network device associates a given ingress network traffic flow with a particular application by recognizing that the network traffic flow has a network traffic flow signature that corresponds to the application. For this purpose, the managed network device applies one or multiple rules and considers one or multiple network traffic flow attributes. In this context, a "network traffic flow signature" (also called an "application signature" herein) generally refers to a collection of network traffic flow attributes associated with a network traffic flow, which correspond to a particular application. In an example, network traffic flow attributes appear in a packet header. In another example, network traffic flow attributes appear in a packet payload. In examples, a network traffic flow attribute is a particular session protocol or an Internet Protocol (IP) Address associated with a network traffic flow. In general, network traffic flow attributes may be any of a number of characteristics associated with any of layers 3, 4, 5, 6 or 7 of the Open Systems Interconnection (OSI) model.

Especially in view of the rapid growth of the Software-as-a-Service (SaaS) market, the number of network traffic signatures to be recognized and handled by managed network devices is ever increasing. Moreover, existing applications are constantly evolving, which results in the network traffic signatures of these applications changing over time. For purposes of keeping up-to-date with the latest network traffic signatures, the NMS cluster may apply application intelligence that the NMS cluster receives from one or multiple application intelligence sources. In the context that is used herein, "application intelligence" for an application refers to one or multiple insights about the application. In an example, application intelligence includes network traffic flow attributes that define a network traffic flow signature for an application. In another example, application intelligence includes a reputation for an application, such as whether the application is considered trustworthy. In another example application intelligence reveals whether an application complies with a particular standard (e.g., whether the application complies with a Payment Card Industry Data Security Standard (PCI DSS)). In another example, application intelligence specifies a geographical location associated with an application (e.g., a geographical location of one or multiple servers that host the application).

A centralized management service of an NMS cluster may decide to update managed network devices so that the managed network devices recognize network traffic flows based on updated or new application intelligence. In one approach, updating managed network devices involves updating software on the managed devices (e.g., downloading software to the managed software devices and rebooting the devices). This approach, however, may impose a significant delay between the time that new or updated application intelligence is received and the time that the managed network devices are updated.

In accordance with example implementations, an NMS service updates managed network devices with the latest application intelligence by pushing application tags to the managed network devices. Among other content, an application tag includes data representing rules and metadata that are to be applied by a managed network device for purposes of the device recognizing certain network traffic flows and determining a treatment to apply to these network traffic flows. By applying the rules and metadata contained in an application tag, the managed network device is able to recognize whether a given ingress network traffic flow is covered by a particular policy corresponding to the application tag. Moreover, by applying the rules and metadata contained in an application tag, the managed network device is configured to apply a particular policy treatment (e.g., a security policy treatment, a QoS policy treatment or a routing policy treatment) to ingress network traffic flows that are covered by the policy. The managed network device is constructed to extract the rules and metadata contained in newly-received application tags and apply the rules and metadata without requiring a software update to the device (e.g., without requiring the managed network device to download software from a centralized NMS service and perform a subsequent reboot).

In accordance with example implementations, an application tag belongs to one of two categories, or types: an individual, or base application tag, which is specific to a particular application; or a group application tag, which is affiliated with an application category, and as such, it may be associated with multiple applications. In an example, the rules and metadata for a base application tag may correspond to a single network traffic flow signature that is provided, for the corresponding application, by a single application intelligence source. In another example, the rules and metadata for a base application tag may correspond to multiple network traffic flow signatures that are provided, for the application, by multiple, respective application intelligence sources. The rules and metadata for a group application tag may be the result of intelligence provided by one or multiple application intelligence sources. The rules and metadata for a group application tag correspond to network traffic flow signatures that are associated with a particular category of applications.

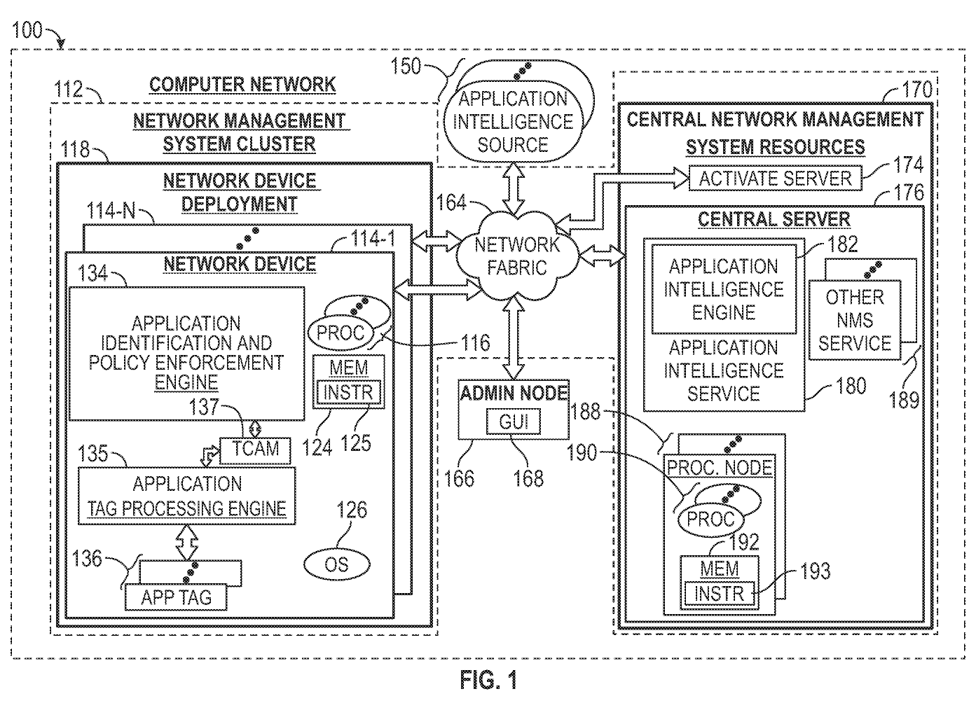

Referring to FIG. 1, as a more specific example, a computer network 100 includes one or multiple network management system (NMS) clusters 112 (one exemplary NMS cluster 112 being depicted in FIG. 1). The NMS cluster 112 includes central NMS resources 170 and one or multiple network device deployments 118 (one exemplary network device deployment 118 being depicted in FIG. 1). The network device deployment 118 includes managed network devices 114. FIG. 1 depicts N managed network devices 114-4 to 114-N, with specific components being depicted for an exemplary managed network device 114-1. One or multiple other network devices 114 may have similar components to managed network device 114-1, in accordance with example implementations.

In an example, the network device deployment 118 corresponds to a local branch network (e.g., a local area network (LAN)). In other examples, a network device deployment 118 includes multiple local branch networks. In other examples, the network device deployment 118 is associated with a data center or an edge computing system. Moreover, the network device deployment 118 may be associated with specific geographical location, such as a campus site, a data center site, city, state, country or other geographical designation.

In the context that is used herein, a "network device" refers to an actual, or physical electronic component, which enables data communication between other components. In an example, a managed network device 114 is an access switch. In an example, a managed network device 114 operates at layer three (L3) of the OSI model to connect both components of a computer network together and connect computer networks together. An L3 network device performs routing between multiple computer networks. In more specific examples, a managed network device 114 may be any of the following individually or in combination: an access switch; an Ethernet Private Virtual Network (EVPN) switch; a gateway; a router; a bridge; a component of a Gen-Z or a Compute Express Link (CXL) network; or a top-of-the-rack (ToR) switch.

In accordance with example implementations, a managed network device 114 applies application-centric policies to network traffic flows. As depicted in FIG. 1, for this purpose, the network device 114-1 includes an application identification and policy enforcement engine 134 (called the "enforcement engine 134" herein). The enforcement engine 134 is constructed to apply one or multiple treatments (e.g., one or multiple of a security treatment, a QoS treatment and/or a routing treatment) to a given ingress network traffic flow based on the network traffic flow's application association, among other possible criteria (e.g., destination and source roles associated with the network traffic flow).

In an example, the enforcement engine 134 determines whether a given ingress network traffic flow is prohibited by a security policy, and if so, the enforcement engine 134 drops the packets of the network traffic flow. In another example, the enforcement engine 134 determines an IP forwarding address for an ingress network traffic flow based on a routing policy. In another example, the enforcement engine 134 determines a QoS treatment (e.g., a queue size) for a given ingress network traffic flow based on a QoS policy. In an example, a policy may be a group-based policy (GBP), which covers network traffic flows based on application affiliation, as well as destination and source role affiliations.

In accordance with some implementations, the enforcement engine 134 recognizes network traffic flow signatures and applies applicable policies using a ternary content addressable memory (TCAM) 137 of the network device 114-1. The TCAM 137 contains entries (called "TCAM entries" herein) that allow the enforcement engine 134 to quickly and efficiently recognize associate network traffic flows with policies and determine the treatments to be applied per the policies. In general, a TCAM entry contains a mask, a value and a result.

As depicted in FIG. 1, in accordance with example implementations, the managed network device 114-1 includes an application tag processing engine 135 that programs the TCAM 137 based on rules and metadata that are contained in application tags 136. In accordance with example implementations, an application intelligence service 180 of the central NMS resources 170 pushes application tags 136 to managed network devices 114, such as the network device 114-1. A given application tag 136 may be an individual, or base, application tag, which is specific to a particular application or a group application tag, which is affiliated with a category of applications.

In the context that is used herein, an "application tag" generally refers to a unit of data that configures a network device to, among other possible functions, recognize a network traffic flow that is affiliated with a particular application. In an example, a particular application tag 136 includes data representing rules and metadata that are to be applied by the network device 114-1 for purposes of configuring the network device 114-1 to recognize network traffic flows that are covered by an application-centric policy. Moreover, in an example, the rules and metadata configure the network device 114-1 to determine a treatment to be applied per the application-centric policy.

For a given application tag 136, the application tag processing engine 135 programs the TCAM 137 with one or multiple TCAM entries that correspond to the rules and metadata. In an example, a particular TCAM entry contains a mask that represents IP addresses and a value (e.g., value that corresponds to a combination of L3, L4, L5, L6 and/or L7 parameters) that corresponds to a network traffic flow signature. In an example, the value also includes roles for the sender (the source) and receiver (the destination) of the network traffic flow. Regardless of the particular content of the value, if information, extracted by the enforcement engine 134 and from an ingress network traffic flow, matches the mask and value of a particular TCAM entry, then a match, or "hit," occurs. Due to the nature of content addressable memory, the enforcement engine 134 looks up matching TCAM entry(ies) by addressing the TCAM 137 with specific content, which here, is a combination mask and value corresponding to information that is extracted by the enforcement engine 134 from an ingress network traffic flow. In an example, the enforcement engine 134 extracts the information from the header of a packet of the ingress network traffic flow. In another example, the enforcement engine 134 extracts the information from the body of a packet of the ingress network traffic flow. In another example, the enforcement engine 134 extracts the information from both the header and body of a packet of the ingress network traffic flow.

In an example, for an application tag 136 that corresponds to a security policy, a corresponding TCAM entry includes a result of "permit" or "deny." Therefore, for a particular ingress network traffic flow, a hit on the TCAM entry returns a decision (permit or deny) for the enforcement engine 134. In another example, for an application tag 136 that corresponds to a routing policy, a corresponding TCAM entry includes an IP fowarding address in the result field. Therefore, for a particular ingress network traffic flow, a hit on the TCAM entry returns an IP forwarding address for the network traffic flow. In another example, for an application tag 136 that corresponds to a QoS policy, a corresponding TCAM entry includes a pointer to a QoS policer of the enforcement engine 134. Therefore, for a particular ingress network traffic flow, a hit on the TCAM entry causes the enforcement engine 134 to direct the processing of the network traffic flow to the QoS policer.

In accordance with example implementations, the managed network device 114 is a computer platform. In the context that is used herein, a "computer platform" refers to a processor-based electronic device, which has an associated operating system. For the example implementation that is depicted in FIG. 1, the network device 114-1 includes an operating system 126, and one or multiple hardware processors 116. In an example, a hardware processor 116 includes one or multiple central processing unit (CPU) cores. In another example, a hardware processor 116 includes one or multiple CPU packages, or sockets.

As depicted in FIG. 1, the network device 114-1 further includes a system memory 124. The system memory 124 as well as other memories that are discussed herein are non-transitory storage media that may be formed from semiconductor storage devices, memristor-based storage devices, magnetic storage devices, phase change memory devices, a combination of devices of one or more of these storage technologies, and so forth. The non-transitory storage media may represent a collection of volatile memory devices and non-volatile memory devices, in accordance with example implementations.

As used herein, an "engine," such as the enforcement engine 134 and/or the application tag processing engine 135, can refer to one or more circuits. For example, the circuits may be hardware processing circuits, which can include any or some combination of a microprocessor, a core of a multi-core microprocessor, a microcontroller, a programmable integrated circuit (e.g., a programmable logic device (PLD), such as a complex PLD (CPLD)), a programmable gate array (e.g., field programmable gate array (FPGA)), an application specific integrated circuit (ASIC), or another hardware processing circuit. An "engine" can refer to a combination of one or more hardware processing circuits and machine-readable instructions (software and/or firmware) executable on the one or more hardware processing circuits. In an example, the enforcement engine 134 and/or the application tag processing engine 135, may be formed by one or multiple hardware processors 116 of the network device 114-1 executing machine-readable instructions 125 that are stored in the memory 124. In an example, in accordance with some implementations, the instructions 125 that are executed to form the enforcement engine 134 and/or the application tag processing engine 135 are firmware instructions. In other examples, the enforcement engine 134 and/or the application tag processing engine 135 are formed in whole or in part by a PLD, ASIC, FPGA or other hardware of the network device 114-1.

The managed network devices 114 and the central NMS resources 170 communicate over network fabric 164. In accordance with example implementations, the network fabric 164 may be associated with one or multiple types of communication networks, such as (as examples) Fibre Channel networks, Compute Express Link (CXL) fabric, dedicated management networks, LANs, wide area networks (WANs), global networks (e.g., the Internet), wireless networks, or any combination thereof. As depicted in FIG. 1, the central NMS resources 170 are also connected to the network fabric 164.

The central NMS resources 170 include a central server 176 that includes an application intelligence engine 182 that provides the application intelligence service 180. As described further herein, an application intelligence download staging service (e.g., a service that is part of the application intelligence engine 182 or a service that is located outside of the central NMS resources 170) continually polls application intelligence sources 150 for application intelligence bundles to download. In accordance with example implementations, the application intelligence sources 150 are associated with respective application intelligence vendors.

In the context used herein, an application intelligence "bundle" is associated with a particular application and contains data representing intelligence insights about the application. In an example, the intelligence insights include a network traffic flow signature (also called an "application signature" herein) associated with the application. In another example, the intelligence insights represent whether a particular application complies with one or multiple standards. In examples, the intelligence insights may represent whether a particular application complies with one or multiple of the PCI DSS standard, the Health Insurance Portability and Accountability Act (HIPAA), General Data Protection Regulation (GDPR), or one or multiple other standard(s). In another example, the intelligence insights represent a reputation of an application, such as whether or not the application is considered trustworthy.

In another example, the intelligence insights indicate that the application is associated with a particular geographical location or region. In this manner, the application is hosted on one or multiple servers that are located in the geographical regions. In examples, the intelligence insights may associate an application with a particular US state, a particular country or another geographical region (e.g., the Iberian Peninsula, North America, South America, or a smaller or a larger geographical region).

An application intelligence bundle includes data that represents identifying information for the associated application. In an example, an application intelligence bundle may include a vendor-assigned identifier (ID) (called the "vendor application ID" herein) for the application. Here, "vendor" refers to the intelligence source provider. In another example, an application intelligence bundle includes data that represents a vendor-assigned name (called the "vendor application name" herein) for the application. In this context, a "name" refers to ordinary human-readable text that conveys a description of a characteristic associated with the application (e.g., a brand, a manufacturer, an application type, a product name or other description), whereas an identifier, such as the vendor application ID (e.g., an alphanumeric string), does not describe a characteristic associated with the application in ordinary human-readable text.

The application intelligence engine 182, in general, incorporates the application intelligence from downloaded application intelligence bundles into application tags 136. The application intelligence engine 182 pushes the application tags 136 to the managed network devices 114 for purposes of updating the managed network devices 114 with new and/or updated application intelligence.

In accordance with example implementations, a network administrator may input data for configuring the application intelligence service 180 via an administrative dashboard. In an example and as further described herein, the network administrative may define application tag groups, among other configuration options for the application intelligence service 180. In an example, the administrative dashboard may be a graphical user interface (GUI) 168 that is provided by an administrative node 166 that is coupled to the network fabric 164. In an example, the GUI 168 may be provided by specific client software that is executed on the administrative node 166 or, as another example, may be provided by an Internet browser that executes on the administrative node 166. An administrative dashboard, such as the GUI 168, may, in general, provide user access to a suite of NMS services (e.g., the application intelligence service 180 as well as one or multiple other NMS services 189) for managing various aspects of the NMS cluster 112.

In addition to the application intelligence engine 182, the central server 176 may include other NMS engines that provide other NMS services 189 for the managed network devices 114. In an example, through an NMS service 189, a network administrator may configure the managed network devices 114. In another example, an NMS service 189 schedules and initiates firmware upgrades on managed network devices 114. In another example, one or multiple NMS services 189 may be used to visualize, analyze, log, collect query and/or monitoring network telemetry metrics that are reported by the network devices 114. In another example, an NMS service 189 identifies potential or actual network device failure issues based on network telemetry metric values. In another example, an NMS service 189 identifies potential or actual network performance issues (e.g., issues with a network device or a subnet) based on network telemetry metric values. In another example, an NMS service 189 oversees remedial actions to correct network issues. In another example, an NMS service 189 identifies performance issues with a customer device (e.g., a server) that is connected to or part of the network device deployment 118. In another example, an NMS service 189 logs network events and maintains one or multiple corresponding logs. In another example, an NMS service 189 serves responses to queries related to obtaining information about the network device deployment 118. In another example, an NMS service 189 provides recommended solutions (e.g., suggested reconfigurations, suggested upgrades and/or suggested replacements) to address network issues.

In accordance with some implementations, the central server 176 includes one or multiple processing nodes 188 that execute machine-readable instructions (or "software"). In the context that is used herein, a "processing node" (or "node") refers to a processor-based entity that has an associated set of hardware and software resources. As depicted in FIG. 1, a processing node 188 may have one or multiple associated hardware processors 190 (e.g., one or multiple CPU cores) and an associated memory 192. In accordance with some implementations, the memory 192 may store machine-readable instructions 193 that, when executed by one or multiple hardware processors 190, cause the hardware processor(s) 190 to form instances of components of the central server 176. In an example, the memory 192 may store machine-readable instructions 193 that, when executed by one or multiple hardware processors 190, cause the hardware processor(s) 190 to form an instance of the application intelligence engine 182, as well as form instances of other NMS engines that provide the other NMS service(s) 189.

In accordance with example implementations, a processing node 188 may be an actual, or physical, entity, such as a computer platform or a part (e.g., a part corresponding to a group of CPU cores or CPU cores) of a computer platform. In examples, a computer platform may be a rack-mounted server (e.g., a density line (DL) rack server) or an enclosure-based server (e.g., a blade server). In another example, a processing node 188 may be a virtual entity that is an abstraction of physical hardware and software resources, such as a virtual machine. Depending on the particular implementation, multiple processing nodes 188 may be located on one or multiple virtual or physical machines. Moreover, in accordance with example implementations, the physical nodes 188 may be distributed across virtual and/or physical machines that are located at the same geographical location (e.g., located in the same data center) or located at different geographical locations (e.g., physical nodes 188 located in different data centers).

In addition to the central server 176, the central NMS resources 170 may include an activate server 174. In an example, when a managed network device 114 first connects to the network device deployment 118, a dynamic host configuration protocol (DHCP) server (not shown) of the computer network 100 provides, to the managed network device 114, an IP address of the activate server 174 (e.g., provide the IP address as a DHCP option). The activate server 174, among its other functions, validates the network device 114, and the activate server 174 provides, to the network device 114, upon successful validation, network artifacts (e.g., an IP address and credentials) for connecting to the central server 176.

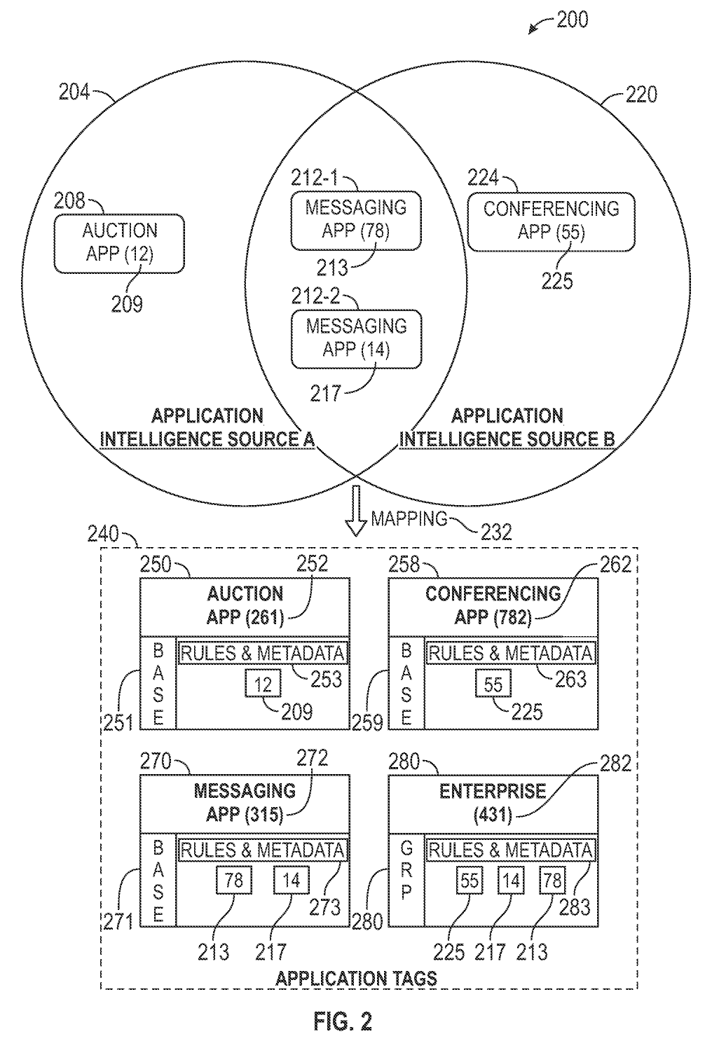

FIG. 2 depicts an illustration 200 of a mapping 232 of vendor-specific application identifiers to vendor agnostic application tags 240, according to an example implementation. Referring to FIG. 2, the mapping 232 is performed by an application intelligence engine, such as the application intelligence engine 182 of FIG. 1. Application intelligence sources A and B correspond to respective application intelligence vendors. The application intelligent sources 150 of FIG. 1 are examples of the application sources A and B.

The application intelligence source A provides application intelligence for a set 204 of applications including an exemplary online auction application 208 and an exemplary messaging application 212-1. The application intelligence provided by the application intelligence source A may include data representing insights about the applications 208 and 212-1, such as corresponding network traffic flow signatures, reputations, geographical locations, compliances with standards, as well as other and/or different information.

As also depicted in FIG. 2, the application intelligence source B provides application intelligence for a set 220 of applications including an exemplary messaging application 212-2 and an exemplary conferencing application 224. The application intelligence may include data representing insights about the applications 212-2 and 224.

For this example, the messaging applications 212-1 and 212-2 are the same. However, the application intelligence sources A and B may provide different sets of application intelligence for the messaging application 212, including different network traffic flow signatures, as well as other information (e.g., reputations, standard compliances or geographical location information) that supplement the intelligence from another or provide more recent intelligence. Moreover, the application intelligence sources A and B use different vendor application IDs to identify their respective applications. In this manner, the application intelligence source A identifies the messaging application 212-1 using a particular vendor application ID 213 of "78," and the application intelligence source B identifies the messaging application 212-2 using a vendor application ID 217 of "14." In a similar manner, the online auction application 208 has a vendor application ID 209 of "12," and the conferencing application 224 has a vendor application ID 225 of "55." In addition to assigning different vendor application IDs, the application intelligence sources A and B may assign different vendor names to their respective applications.

For purposes of generating group application tags, the application intelligence engine may group applications into particular categories, or types. For example, the application intelligence engine may group the messaging application 212 and the conferencing application 224 into an enterprise group. The application intelligence engine applies a mapping transformation 232 to the application intelligence provided by application intelligence sources A and B to produce the exemplary vendor agnostic application tags 240. For the example depicted in FIG. 2, the application tags 240 include group application tag 280 (corresponding to the enterprise group of applications) and base application tags 250, 258 and 270 (corresponding to respective individual applications).

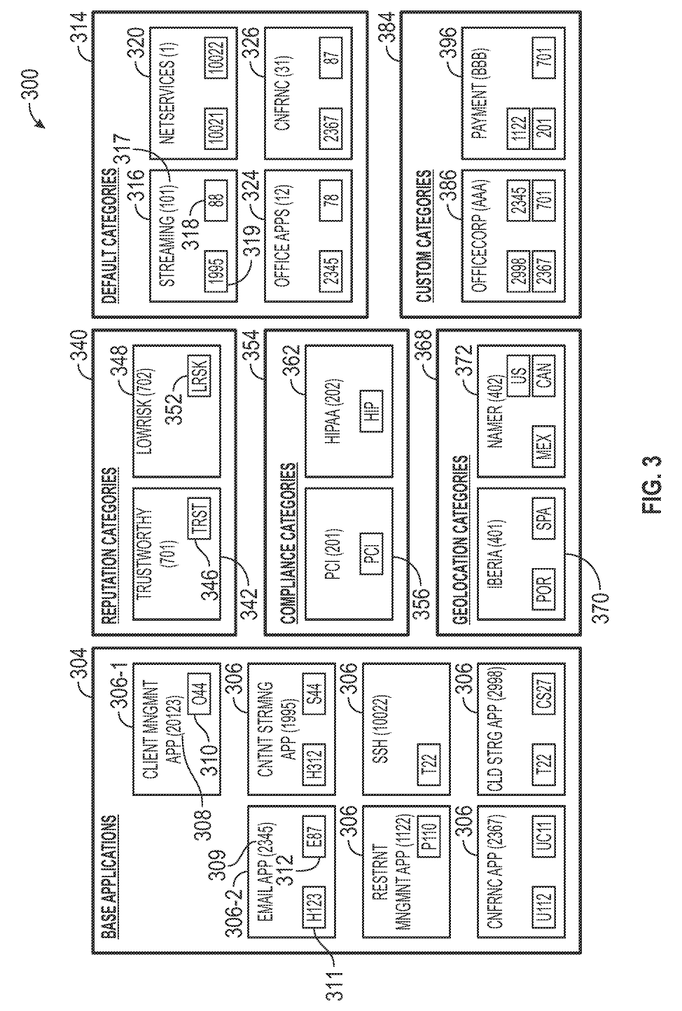

As described in more detail below in connection with FIG. 3, the correspondence between the applications and the corresponding application tags may depend on a number of different factors. A given application may be mapped to an individual, or base, application tag and be mapped to zero, one or multiple group application tags.

The base application tag 250 corresponds to the online auction application 208. The base application tag 250 includes data representing the specific application tag type (here, a "base" type). The application intelligence engine assigns a UUID to each application that is tracked by the application intelligence engine, and the base application tag 250 includes data representing an application UUID 252 for the online auction application of "261." It is noted that a "UUID" may alternatively be referred to as a globally unique identifier, or "GUID." In accordance with example implementations, the UUID is a namespace that is 128 bits long and is described in, "A Universally Unique IDentifier (UUID) URN Namespace," Request for Comments (RFC) 4122 (July 2015).

As depicted at 253, the base application tag 250 includes data representing rules and metadata to configure a managed network device to recognize network traffic flows corresponding to the online auction application 208. Moreover, the rules and metadata may configure the managed network device to apply a particular policy treatment (e.g., a security, routing or QoS treatment) to the recognized network traffic flows. The application intelligence engine derives the rules and metadata for the base application tag 250 from the application intelligence that is provided by application intelligence source A. The association between the base application tag 250 and the application intelligence source A is depicted in FIG. 2 by the vendor application ID 209 inside the tag 250. The base application tag 250 may or may not include data representing the vendor application ID 209, depending on the particular implementation. Regardless, the application intelligence engine maintains mappings between vendor application IDs and application UUIDs, such as a mapping between the vendor application ID 209 and the application UUID 252.

The base application tag 270 corresponds to the messaging application 212. The base application tag 270 includes data representing an application UUID 272 of "315" for the messaging application 212. The base application tag 270 also includes data 271 identifying the tag 270 as being a base application tag. As depicted at 273, the base application tag 270 includes data representing rules and metadata to configure a managed network device to recognize network traffic flows corresponding to the messaging application 212. Moreover, the rules and metadata may configure the managed network device to apply a particular policy treatment (e.g., a security, routing or QoS treatment) to the recognized network traffic flows. As depicted by the vendor application IDs 213 and 217 inside the base application tag 270, the rules are metadata are derived from application intelligence that is provided by application intelligence sources A and B.

The base application tag 258 corresponds to the conferencing application 224. The base application tag 258 has a corresponding application UUID 262 of "782." As depicted at 263, the base application tag 258 includes data representing rules and metadata to configure a managed network device to recognize network traffic flows corresponding to the conferencing application 224. Moreover, the rules and metadata may configure the managed network device to apply a particular policy treatment (e.g., a security, routing or QoS treatment) to the recognized network traffic flows. As depicted by the vendor application ID 225 inside the base application tag 258, the rules are metadata are derived from application intelligence that is provided by application intelligence source B.

The group application tag 280 corresponds to an enterprise group of applications, including the messaging application and the conferencing application 224. The group application tag 280 has a corresponding UUID 282 of "431." As depicted at 283, the group application tag 280 includes data representing rules and metadata to configure a managed network device to recognize network traffic flows corresponding to all of the applications in the corresponding group, which for this example, includes the messaging application 212 and the conferencing application 224. Moreover, the rules and metadata may configure the managed network device to apply a particular policy treatment (e.g., a security, routing or QoS treatment) to the recognized network traffic flows. As depicted by the vendor application IDs 213, 217 and 225 inside the group application tag 280, the rules are metadata are derived from application intelligence that is provided by both application intelligence sources A and B.

For this example, the group application tag 280 corresponds to a custom category that is defined by a user. For example, a network administrator may create a custom group by specifying a list of application UUIDs to include in the custom group. The application intelligence engine then creates a group application tag for the custom group, updates the group application tag as new application intelligence becomes available and distributes any new corresponding group application tags to the managed network devices. A user may subsequently modify the custom group of applications by adding or deleting member applications, and if this happens, the application intelligence engine distributes a new group application based on the new application membership.

As described further below in connection with FIG. 3, the application intelligence engine may further allow a group of applications to be defined based on criteria other than application UUIDs. For example, a user may designate a particular application intelligence attribute (e.g., a particular reputation, geographical location or specification compliance) for a group of applications corresponding to a particular group application tag.

FIG. 3, depicts an illustration 300 of different types, or categories, of application tags that may be generated by an application intelligence engine, according to an example implementation. Referring to FIG. 3, a collection 304 of exemplary base application tags 306 may be defined for respective individual applications. In an example, a user may identify (e.g., identify via the GUI 168 of FIG. 1) a specific application for which the application intelligence engine is to generate a base application tag (such as one of the exemplary base application tags 306), provided that application intelligence for the application is available. In another example, a user may select (e.g., select via the GUI 168 of FIG. 1) an application category, and the application intelligence engine generates a base application tag for any application corresponding to the category and for which application intelligence is available.

As depicted in FIG. 3, a given base application tag 306 includes data representing an application UUID, which is assigned by the application intelligence engine to the corresponding application. In an example, for a base application, the application UUID also serves as a base application tag UUID. In another example, the application intelligence engine assigns a UUID to each base application tag 306, which is different from the corresponding application UUID.

FIG. 3 depicts a specific exemplary base application tag 306-1 that corresponds to a particular client management application and includes data representing rules and metadata to configure a managed network device to recognize a network traffic flow signatures corresponding to the client management application. The base application tag 306-1 has a UUID 308, which, according to example implementations, is the UUID of the client management application. As shown in FIG. 3, the base application tag 306-1 is associated with a vendor application ID 310 (i.e., the ID used by an intelligence source vendor to identify the client management application). The base application tag 306-1 may or may not include data representing the vendor application ID 310, depending on the particular implementation.

In another example, an exemplary base application tag 306-2 corresponds to a particular electronic mail (email) application and includes data representing rules and metadata to configure a managed network device to recognize one or multiple network traffic flow signatures corresponding to the email application. The base application tag 306-2 has a UUID 309, which, according to example implementations, is the UUID of the email application. As shown in FIG. 3, the base application tag 306-2 is associated with vendor application IDs 311 and 312. (i.e., the ID used by two intelligence source vendors to respectfully identify the email application). The base application tag 306-2 may or may not include data representing the vendor application IDs 311 and 312, depending on the particular implementation.

The illustration 300 further depicts other types, or categories, of application tags (called "group application tags") that correspond application groups. In an example, the application intelligence engine generates group application tags that are grouped according to respective default categories 314. As the name implies, a default category 314 is assigned by the application intelligence engine. FIG. 3 depicts an exemplary group application tag 316 for streaming applications. The group application tag 316 includes a group tag UUID (an application tag UUID). Moreover, as depicted at 319 and 324, the group application tag 316 includes rules and metadata to configure a managed network device to identify network traffic flow signatures corresponding to a content streaming application (having a UUID of "1995") and another streaming application (having a UUID of "88"). FIG. 3 further depicts a group application tag 320 for net services applications, a group application tag 324 for office applications and a group application tag 326 for conferencing applications.

FIG. 3 further depicts group application tags that belong to respective custom categories 384. A user (e.g., a system administrator) may define (e.g., via a GUI, such as the GUI 168 of FIG. 1) one or multiple custom application groups, and the application intelligence engine generates a group application tag for each custom application group. For example, a user may define enterprise office applications as a custom application group, and the application intelligence engine generates a corresponding group application tag 386 corresponding to the group of enterprise office applications. In an example, for purpose of creating the enterprise office application group, the user may select application UUIDs of specific enterprise office applications. In another example, a user may define payment applications as a custom application group, and the application intelligence engine generates a corresponding group application tag 396.

In accordance with example implementations, the application intelligence engine generates group application tags that belong to respective reputation categories 340. For example, as depicted in FIG. 3, application intelligence engine may classify a particular application as belonging to a particular reputation group 340. For example, the application intelligence for a given application may classify the application as being trustworthy, and due to the application being trustworthy, the application intelligence engine assigns the application to a trustworthy group application tag 342. As depicted in FIG. 3, the trustworthy group application tag 342 may contain data 346 representing the tag 342 as pertaining to trustworthy applications. In another example, the application intelligence engine may generate a low-risk group application tag 348 that corresponds to applications that, based on application intelligence, are considered low risk. The low-risk group application tag 348 may include data 352 representing the particular low risk application tag type.

The application intelligence engine generates group application tags that belong to respective compliance categories 354. In an example, the application intelligence engine generates a group application tag 356 for applications that, as indicated by application intelligence, are PCI compliant. In another example, the application intelligence engine generates a group application tag 362 for applications that, as indicated by application intelligence, comply with HIPAA.

The application intelligence engine generates group application tags that belong to respective geographical location categories 368. In an example, the application intelligence engine generates a group application tag 370 for applications that are indicated by application intelligence to be associated with geographical locations (e.g., Portugal or Spain) on the Iberian Peninsula. In another example, the application intelligence engine generates a group application tag 372 for applications that, as indicated by application intelligence, are associated with geographical locations within North America.

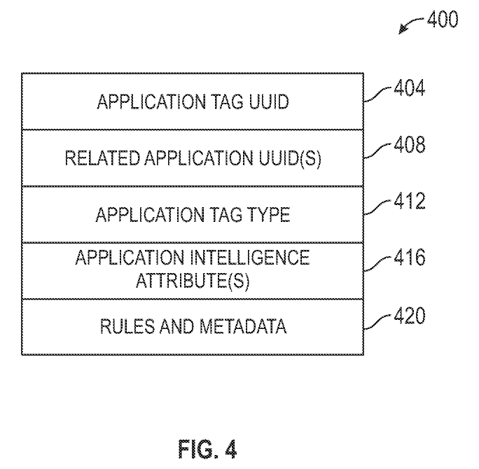

FIG. 4 depicts a content of an application tag 400 in accordance with example implementations. Referring to FIG. 4, the application tag 400 includes data that identifies an application tag type 412. In an example, the application tag type 412 is a base application tag that corresponds to a single application. In another example, the application tag type 412 is a group application tag type that corresponds to a group of applications.

The application tag 400 further includes data that represents an application tag UUID 404. In an example, the application tag 400 is a base application tag corresponding to a single application, and the application tag UUID 404 is the same UUID used by the application intelligence engine to identify the application. In another example, the application tag 400 is a base application tag corresponding to a single application, the application intelligence engine generates an application UUID for the application, and the application intelligence engine generates an application tag UUID 404 that uniquely identifies the application tag 404. In another example, the application tag 400 is a group application tag that is directed to a group of applications, and the application intelligence engine generates an application tag UUID 404 that uniquely identifies the application tag 400 and is different from any of the application UUIDs.

As also depicted in FIG. 4, in accordance with example implementations, the application tag 400 includes data that represents one or multiple related application UUIDs 408. In an example, the application tag 400 is a base application tag that corresponds to a single application and has a unique application tag UUID 404, and the related application UUID 408 uniquely identifies the single application. In another example, the application tag 400 is a group application tag, and the related application UUIDs identify the corresponding applications.

The application tag 400 may further include data that represents one or multiple application intelligence attributes 416. In an example, for a group application tag 400, an application intelligence attribute 416 represents that the group application tag 400 corresponds to applications that are associated with a specific geographical location (e.g., North America or South America). In another example, for a group application tag 400, an application intelligence attribute 416 represents that the group application tag 400 corresponds to applications that are considered trustworthy. In another example, for a group application tag 400, an application intelligence attribute 416 represents that the group application tag 400 corresponds to applications that are considered to comply with a particular standard (e.g., a PCI DSS standard, a HIPAA standard or GDPR standard).

The application tag 400 includes data that, as depicted at 420, represents rules and metadata. In an example, the rules and metadata configure a managed network device to recognize one or multiple network traffic flows. In an example, for a base application tag 400 for a single application, the rules and metadata configure a managed network device to recognize a network traffic flow signature of the application provided by an application intelligence source. In another example, for a base application tag 400 for a single application, the rules and metadata configure a managed network device to recognize multiple network traffic flow signatures of the application, as provided by multiple respective application intelligence sources. In an example, for a group application tag 400 for a group of applications, the rules and metadata configure a managed network device to recognize network traffic flow signatures of the applications provided by one or multiple application intelligence sources.

In an example, the rules and metadata correspond to one or multiple entries to be programmed by a managed network device into the managed network device's TCAM. In an example, the rules and metadata include a combination of one or multiple L3, L4, L5, L6 or L7 attributes of a corresponding network traffic flow signature. In an example, the rules and metadata include one or multiple IP address masks of a corresponding network traffic flow signature. In another example, the rules and metadata indicate a policy decision (e.g., pass, deny, an IP forward address or a QoS policer pointer) when a network traffic flow signature is recognized. In another example, the rules and metadata include a source role (the role of the sender of a network traffic flow) and a destination role (the role of a recipient of the network traffic flow).

An application tag may include other and/or different information than what is depicted in FIG. 4 for the application tag 400, in accordance with further implementations. For example, an application tag includes data that represents the corresponding vendor application ID(s). In another example, an application tag includes data that represents the vendor name(s) for the corresponding application(s). In another example, an application tag includes data that represents normalized names (derived by the application intelligence engine) for the corresponding application(s). In another example, an application tag includes data that represents a version of the application tag.

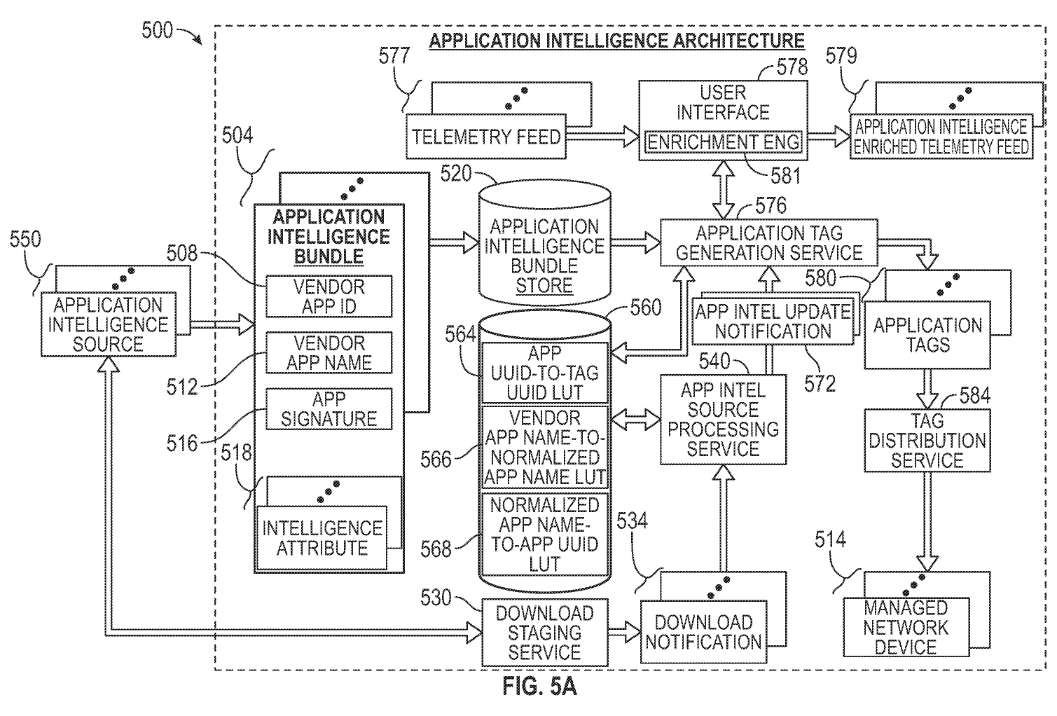

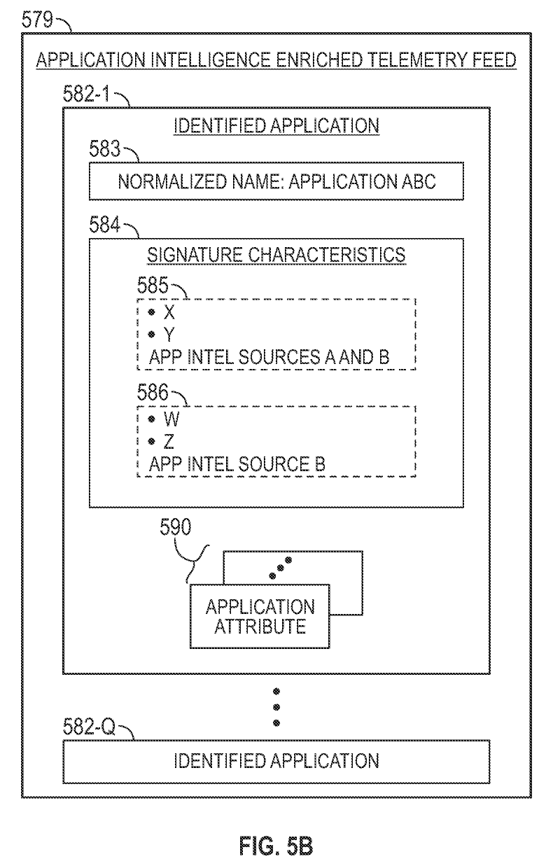

Referring to FIG. 5A, an application intelligence architecture 500 may be used to generate application tags 580 and distribute the application tags 580 to managed network devices 514. The managed network devices 114 of FIG. 1 are examples of the managed network devices 514. In examples, the application tags 580 may be base application tags, group application tags or a combination of base application tags and group application tags. In accordance with example implementations, the application intelligence architecture 500 includes an application intelligence source processing service 540, an application tag generation service 576, a user interface 578 and a tag distribution service 584 which, in accordance with some implementations, may all be part of an application intelligence engine, such as the application intelligence engine 182 of FIG. 1.

In an example, the application intelligence architecture 500 further includes an application intelligence download staging service 530 (called the "download staging service 530" herein), which may also be part of the application intelligence engine. In another example, the download staging service 530 may be separate from the application intelligence engine.

The download staging service 530 regularly (e.g., pursuant to a periodic schedule) polls one or multiple application intelligence sources 550 for application intelligence bundles 504. In an example, the application intelligence sources 550 are associated with respective application intelligence source vendors. In an example, for the purposes of polling an application intelligence source 550, the download staging service 530 submits an application programming interface (API) call to a Uniform Resource Locator (URL) associated with the application intelligence source 550. The application intelligence source 550 provides a corresponding API response. In an example, the API response identifies one or multiple URLs from which the download staging service 530 may access and download one or multiple new application intelligence bundle(s) 504.

In accordance with example implementations, the downloaded application intelligence bundles 504 are stored in an application intelligence bundle store 520. An application intelligence bundle 504, in accordance with example implementations, includes data that represents intelligence insights about a particular application. As depicted in FIG. 5A, an exemplary application intelligence bundle 504 includes data representing a vendor application ID 504, a vendor application name 512 and an application signature 516 (also called a "network traffic flow signature" herein). In an example, a particular application intelligence bundle 504 corresponds to an application for which the application intelligence architecture 500 has already generated one or multiple corresponding application tags 580. In another example, a particular application intelligence bundle 504 corresponds to a new application for which the application intelligence architecture 500 has not generated any application tags 580.

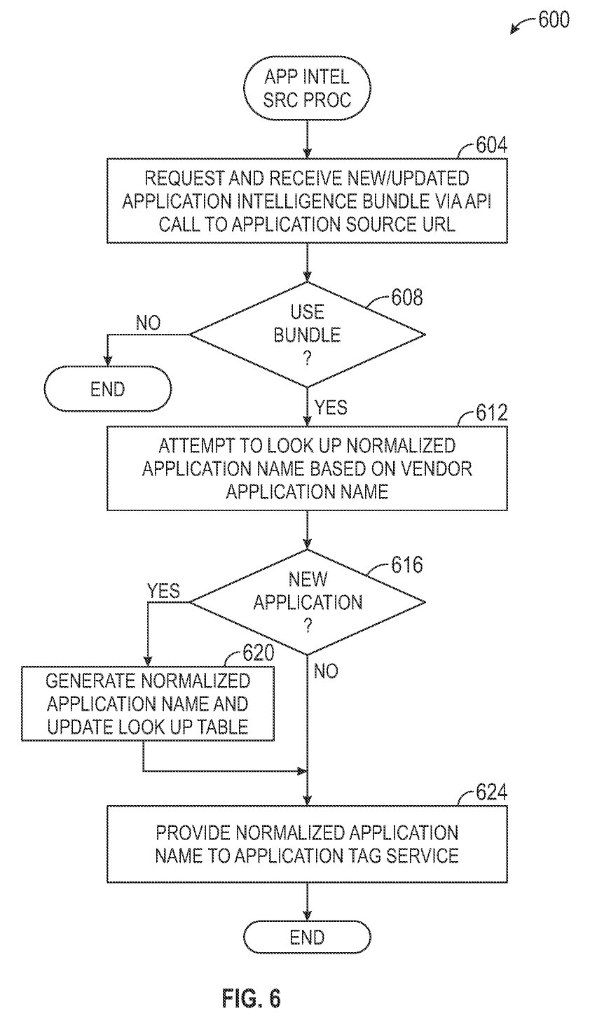

In accordance with example implementations, the download staging service 530, upon retrieving a new application intelligence bundle 504, sends a corresponding download notification 534 to the application intelligence source processing service 540. In response to a download notification 534, the application intelligence source processing service 540 first accesses a vendor application name-to-normalized name look up table 566 for purposes of determining a normalized name for the corresponding application. The determination of the normalized name for the application is discussed further below in connection with FIG. 6.

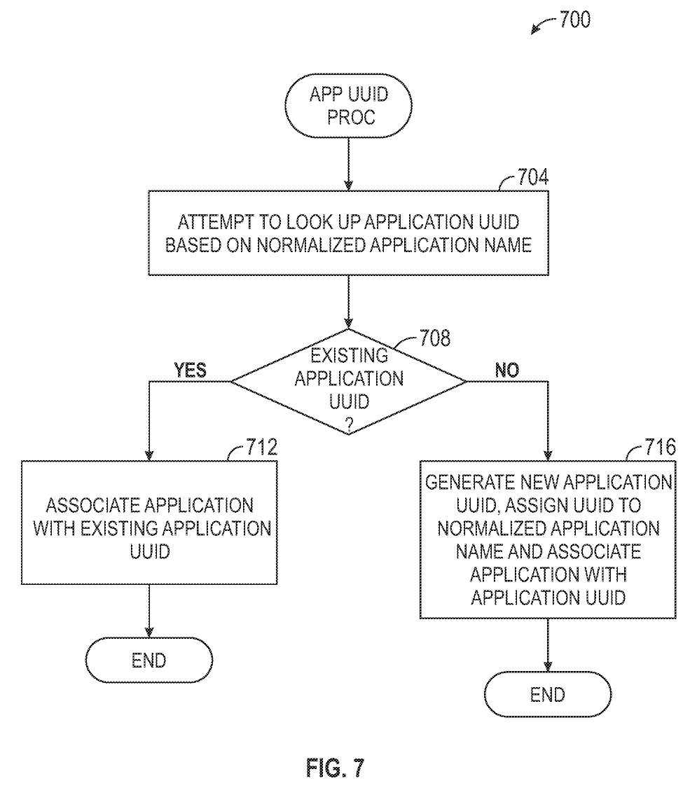

After determining the normalized name for the application, the application intelligence source processing service 540 sends a corresponding application intelligence update notification 572 to the tag generation service 576. The application tag generation service 576, in turn, handles determining an application UUID. For this purpose, the application tag generation service 576 accesses a normalized application name-to-application UUID look up table 568 of the store 560. The determination of the application UUID is described below in connection with FIG. 7. The application tag generation service 576 further, in accordance with example implementations, accesses an application UUID-to-tag UUID look up table 564 for purposes of associating the application with one or multiple application tags 580. Although the look up tables 564, 566 and 568 are depicted as being separate tables in FIG. 5A, in accordance with further implementations the look up tables 564, 566 and 568 may be combined into a single look up table.

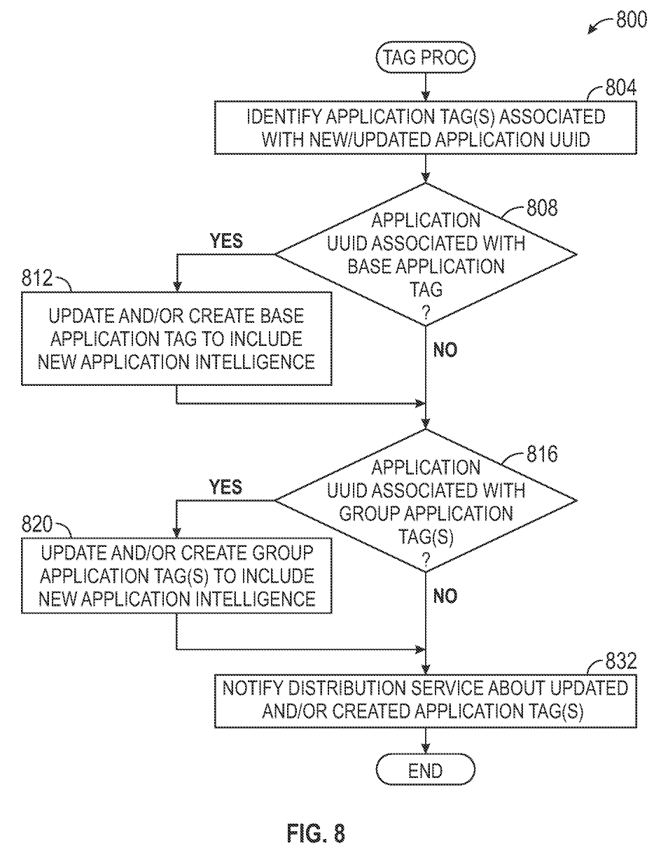

After determining the application UUID for the application, the application tag generation service 576 proceeds to generate the corresponding application tag(s) 580. The generation of the application tags 580 is depicted in more detail and described below in connection with FIG. 8. In an example, a particular application may be associated with a base application tag and one or multiple group application tags. In another example, a particular application may be associated with a base application tag and one or multiple group application tags.

A distribution service 584 of the application intelligence architecture 500 distributes newly generated application tags 580 to the managed network devices 514. In accordance with example implementations, the distribution service 584 pushes the application tags 580 to the managed network devices 514. For this purpose, the distribution service 584 sends each application tag 580 to an IP address and port corresponding to a particular application tag processing engine (e.g., the application tag processing engine 135 of FIG. 1) of a managed network device 514.

The application intelligence architecture 500 provides the ability to cross-pollinate application intelligence learned from multiple application intelligence sources 550. This cross-pollination enriches the application-identifying signatures that are incorporated into the application tags 580. In this manner, a given application tag 580 may have rules and metadata for recognizing a network traffic signature based on flow-identifying characteristics that are provided by multiple application intelligence sources 550. For example, application intelligence source A may provide, for a given application, network traffic flow-identifying characteristics X and Y, whereas application intelligence source B may provide, for the same application, additional network traffic flow-identifying characteristics W and Z. A managed network device configured to inspect traffic flows via an application tag 580 having such cross-pollination of application intelligence is able to detect more applications as well as approve its application detection accuracy.

The cross-pollination of application intelligence by the application intelligence architecture also enriches the information that is presented to the user (e.g., a system administrator). More specifically, the user interface 578, in accordance with example implementations, includes an enrichment engine 581 that enriches received telemetry feeds 577 from managed network devices with application intelligence for purposes of providing enriched telemetry feeds 579. The enriched telemetry feeds 579 contain data representing graphical content that may be viewed by a user (e.g., viewed by a system administrator using the GUI 168 of FIG. 1). The enrichment of the telemetry feeds 577 with application intelligence may be particularly beneficial for purposes of monitoring network traffic activity associated with less capable managed network devices. Less capable managed network devices may be unable to recognized all network traffic flow signature characteristics that are identified by application intelligence (e.g., all network traffic flow signature characteristics contained in the rules and metadata of the application tags 580). The enrichment engine 581 supplements the telemetry feeds 577 from less capable managed network devices so that the enriched telemetry feeds 579 contain all of the multiple vendor application intelligence that is gathered by the application intelligence architecture 500. The enrichment engine 581 has cumulative application intelligence knowledge (provided by all application intelligence sources 550) that is provided by the application tag generation service 576.

FIG. 5B depicts an exemplary enriched telemetry feed 579 as an example of the application intelligence enrichment by the enrichment engine 581. Referring to FIG. 5B, for this example, a less capable managed network device cannot recognize all of the application intelligence-provided network flow signature characteristics of application ABC. The cumulative application intelligence for this example includes network flow signatures for application ABC, which are provided by application intelligence sources A and B. More specifically, for this example, application intelligence source A provides a network flow signature for application ABC, which includes characteristics X and Y; and application intelligence source B provides a network flow signature for application ABC, which includes characteristics X, Y, W and Z. It is noted that the overlapping characteristics X and Y are merely an example, as application intelligence provided by different application intelligence sources may or may not overlap.

The less capable managed network device for this example can recognize characteristics X and Y but is cannot recognize characteristics W and Z. The less capable managed network device, however, recognizes the application ABC responsive to the device recognizing in a network traffic flow having characteristics X and Y, and the less capable managed network device provides a corresponding telemetry feed that indicates recognition of application ABC based on the characteristics X and Y.

The enrichment engine for this example recognizes from the network telemetry feed from the less capable managed network device that the network traffic flow also has characteristics W and Z, and the enrichment engine further recognizes based on the cumulative application intelligence that characteristics W and Z are part of the network traffic flow signature provided by application intelligence source B. The enrichment engine therefore includes, in the enriched telemetry feed 579, content 582-1 representing enriched information about application ABC. As also depicted in FIG. 5B, the enriched telemetry feed 579 for the less capable managed network device may include content for multiple applications (e.g., content 582-1 to 582-Q for Q applications). The network traffic flows of some applications, such as application ABC, may be recognized by the less capable managed network device based on some but not all of the cumulative application intelligence, and the corresponding content 582, such as content 582-1 is further enriched by the enrichment engine. In another example, a managed network device fails to recognize a network traffic flow due to the managed network device being incapable of recognizing the characteristics provided by application intelligence. However, the enrichment engine recognizes the application based on the characteristics in the unenriched network telemetry flow that is provided by the managed network device, and the enrichment engine provides the corresponding content 582. In another example, a managed network device recognizes all characteristics of a network traffic flow, as provided by the cumulative application intelligence, and the managed network device provides the content 582 without further enriching the content 582 with additional characteristics.

In accordance with example implementations, the enrichment engine supplements the content 582 for each recognized application with information about the application. For the example of FIG. 5B, the content 582-1 about application ABC includes a normalized name 583 of application ABC and recognized traffic flow characteristics 584. The characteristics 584 include characteristics 585 that are recognized by the managed network device, such as characteristics X and Y, as well as supplemented characteristics 586 that were not recognized by the managed network device but were recognized and added by the enrichment engine. The enrichment engine may further enrich the content 582-1 to include various intelligence attributes 590 gathered, from one or multiple application intelligence sources, about the application, such as reputations, common vulnerabilities and exposures, certificate compliances and so forth.

Referring to FIG. 6, in accordance with example implementations, an application intelligence engine may perform a technique 600 for purposes of processing an application intelligence bundle. The technique 600 may be performed by download staging service and an application intelligence source processing service, such as the download staging service 530 and the application intelligence source processing service 540, respectively, of FIG. 5A.

Referring to FIG. 6, pursuant to block 604, the download staging service requests and receives a new or updated application bundle via an API call to an application source URL associated with a particular application intelligence source. In an example, the API call is a web API call. In an example, the web API call may be a representation state transfer (REST) API request. In another example, the web API call is a gPRC API request. The application intelligence source provides a corresponding API response. In an example, the API response identifies a URL from which the download staging service may access and download the application intelligence bundles.

Pursuant to decision block 608, the application intelligence source processing service determines whether to use the application intelligence bundle. In an example, decision block 608 may include the application intelligence source processing service determining whether the application intelligence bundle has an appropriate syntax or format. In an example, decision block 608 may include determining whether application tags are being generated for the application named in the application intelligence bundle. In another example, decision block 608 may include determining whether the application intelligence bundle represents new intelligence or intelligence that has previously been provided by another source. In another example, decision block 608 may include determining whether the application intelligence bundle represents a new application signature. In accordance with some implementations, decision block 608 may be performed after the normalized application name is determined (as described below) for purposes of matching up the application with previously-received application intelligence for the application. Regardless of when the decision block 608 is performed, the technique 600 may determine not to further process the application intelligence bundle.

If the application intelligence source processing service determines to further process the application intelligence bundle, then the application intelligence source processing service, pursuant to blocks 612, 616 and 620, determines a normalized application name for the application. More specifically, pursuant to block 612, the application intelligence source processing service attempts to look up a normalized application name for the application based on the corresponding vendor application name (which is provided by the application intelligence bundle). In an example, block 612 may include the application intelligence source processing service accessing a look up table, such as the vendor application name-to-normalized name look up table 566 of FIG. 5A. If, pursuant to decision block 616, the application intelligence source processing service determines that the application is a new application (i.e., the use of the look up table is a "miss"), then, pursuant to decision block 620, the application intelligence source processing service generates a normalized application name for the application and updates the look up table. Pursuant to block 624, the application intelligence source processing service technique 600 provides the normalized application name to an application tag service (e.g., the application tag service 536 of FIG. 5A) for purposes of generating the application tag(s).

FIG. 7 depicts a technique 700 to determine an application UUID for an application. In an example, the technique 700 may be performed by an application tag generation service, such as the application tag generation service 576 of FIG. 5A. Referring to FIG. 7, pursuant to block 704 of the technique 700, the application tag generation service attempts (block 704) to look up the application UUID based on the application's normalized application name. The attempt may or may not be successful.

In an example, block 704 may include the application tag generation service accessing a look up table, such as the normalized application name-to-application UUID look up table 568 of FIG. 5A, and searching for an entry using the normalized application name as a search key. If the table look up is a "hit" and therefore, reveals an entry in the look up table, then the application tag generation service determines (pursuant to decision block 708) that there is an existing application UUID for the normalized application name. Pursuant to block 712, the application tag generation service extracts the application UUID from the found entry in the look up table and associates the application UUID with the application.

If the table look up is a "miss," then the application tag generation service, pursuant to block 716, generates a new application UUID for the application. The application tag generation service, pursuant to block 716, assigns the newly-generated application UUID to the normalized application name. Moreover, the application tag generation service associates the application with the application UUID, pursuant to block 716. The application tag generation service creates an entry in the look up table associating the normalized application name with the newly-generated application UUID.

FIG. 8 depicts a technique 800 for purposes of generating application tags. In an example, the technique 800 may be performed by an application tag generation service, such as the application tag generation service 576 of FIG. 5A. Referring to FIG. 8, pursuant to block 804 of the technique 800, the application tag generation service identifies(block 804) one or multiple application tags that are associated with the application UUID. In an example, block 804 may include the application tag generation service attempting to find the application UUID in a look up table, such as the application UUID to-tag-UUID look up table 564 of FIG. 5A.

In an example, the application tag generation service determines, as a result of block 804, that the application UUID is associated with a base application tag. Responsive to determining this association (pursuant to decision block 808), the application tag generation service, pursuant to block 812, updates and/or creates a base application tag to include the new application intelligence.

In an example, if there is no preexisting base application tag, then the application tag generation service creates a new base application tag. In another example, there is an existing base application tag, then the application tag generation service updates the tag to include the new application intelligence. In an example, the updating may include adding to existing application intelligence. For example, application tag generation service adds data representing rules and metadata corresponding to a new application signature for the application. In another example, the updating includes replacing a particular set of rules and metadata. For example, a particular set of rules and metadata may be associated with a given application intelligence source, and the application tag generation service replaces the rules and metadata to correspond to an updated network traffic flow signature provided by the given application intelligence source.

Pursuant to decision block 816, the application tag generation service determines whether the application UUID is associated with one or multiple group application tags. If so, then, pursuant to block 820, the application tag generation service updates and/or creates the group application tag(s) to include the new application intelligence. Pursuant to block 832, the application tag generation service notifies a distribution service about the updated and/or created application tag(s). In an example, block 832 may include notifying the distribution service 584 of FIG. 5A.

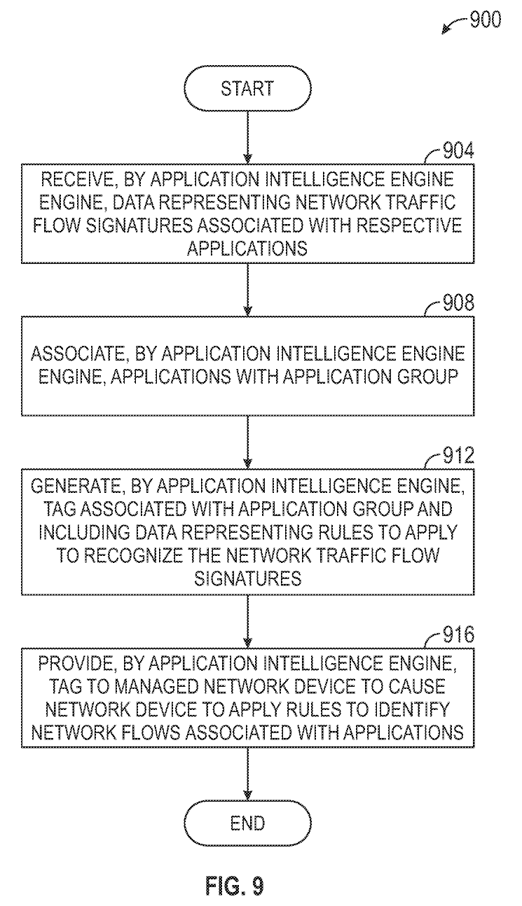

Referring to FIG. 9, in accordance with example implementations, a technique 900 includes receiving (block 904), by an application intelligence engine, application intelligence data representing network traffic flow signatures associated with respective applications. In an example, a network traffic flow signature corresponds to a collection of attributes associated with a network traffic flow, which correspond to a particular application. In an example, a network traffic flow attribute may be any of a number of characteristics associated with any of layers 3, 4, 5, 6 or 7 of the OSI model. In an example, the application intelligence data is provided by an application intelligence source. In an example, the application intelligence source provides a bundle representing intelligence about an application, including data representing a network traffic flow signature corresponding to the application. In an example, the bundle includes data representing a reputation of the application. In an example, the bundle includes data representing whether the application complies with a standard. In an example, the bundle includes data representing a geographical location associated with the application.

The technique 900 includes associating (block 908), by the application intelligence engine, the applications with an application group. In an example, the application group is a default group of applications designated by the application intelligence engine. In another example, the application group is a collection of applications identified by a user. In another example, the application group is a collection of applications having a characteristic in common. In another example, the application group is a collection of applications that are considered to be trustworthy. In another example, the application group is a collection of applications that have a geographical location in common. In another example, the application group is a collection of applications that comply with a particular standard.

Pursuant to block 912, the technique 900 includes generating, by the application intelligence engine, a tag that is associated with the application group and includes data representing rules to apply to recognize the traffic flow signatures. In an example, the tag is a group application tag. In an example, the rules correspond to entries to be programmed in a TCAM of a managed network device. In an example, the tag further includes data representing metadata to configure a managed network device to recognize the traffic flow signatures. In an example, the metadata corresponds to a combination of L3, L4, L5, L6 or L7 of the OSI model. In an example, the tag further includes data representing a UUID. In an example, the tag further includes data representing UUIDs for the applications. In an example, the tag further includes data representing vendor application IDs for the applications.

Pursuant to block 916, the technique 900 includes configuring, by the application intelligence engine, a managed network device to identify network traffic flows associated with the applications. The configuration includes providing the tag to the managed network device to cause the managed network device to apply the rules to identify the network traffic flows. In an example, configuring the managed network device includes an application tag engine programming a TCAM of the managed network device based on the rules. In an example, configuring the managed network device further includes programming the TCAM to apply metadata represented by data of the tag. In an example, configuring the managed network device does not involve a software update for the managed network device.

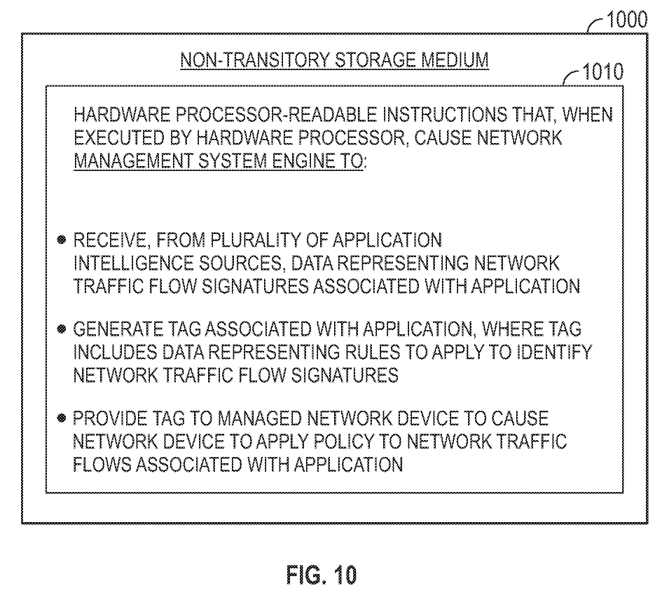

Referring to FIG. 10, in accordance with example implementations, a non-transitory storage medium 1000 stores hardware processor-readable instructions 1010. The instructions 1010, when executed by a hardware processor, cause a network management system engine to receive, from a plurality of application intelligence sources, data that represents network traffic flow signatures that are associated with an application. In an example, the storage medium 1000 is a memory that includes semiconductor storage devices. In an example, the hardware processor includes one or multiple CPU cores. In an example, the network traffic flow signatures are provided by different application intelligence source vendors.

In an example, a network traffic flow signature corresponds to a collection of network traffic flow attributes that are associated with a network traffic flow, correspond to a particular application and distinguish the network traffic flow from a network traffic flow corresponding to another application. In an example, network traffic flow attributes appear in a packet header. In another example, network traffic flow attributes appear in a packet payload. In examples, a network traffic flow attribute is a particular session protocol. In another example, a network traffic flow attribute is an IP address. In an example, a network traffic flow attribute is any of a combination of layer 3, 4, 5, 6 or 7 of the OSI model. In an example, each application intelligence source provides a bundle containing data representing a network traffic flow signature associated with the application. In an example, the application is an SaaS.

The instructions 1010, when executed by the hardware processor, further cause the network management system engine to generate a tag that is associated with the application and includes data representing rules to apply to identify the network traffic flow signatures. In an example, a rule corresponds to one or multiple entries to be entered in a TCAM of a managed network device to cause the managed network device to recognize a network traffic flow signature.

In an example, the tag is a base application tag. In an example, the tag further includes data representing a UUID of the application. In an example, the tag further includes data representing metadata used by a managed network device to identify the network traffic flow signatures. In an example, the metadata represents a combination of one or multiple L3, L4, L5, L6 or L7 OSI model parameters corresponding to the application.

The instructions 1010, when executed by the hardware processor, further cause the network management system engine to provide the tag to a managed network device to cause the network device to apply a policy to network traffic flows that are associated with the application. In an example, the managed network device is an access switch. In another example, the managed network device is a gateway. In another example, the managed network device is a router. In another example, the managed network device is a bridge. In another example, the managed network device is a component of a Gen-Z or a CXL network. In another example, the managed network device is a ToR switch.

In an example, the network management system engine pushes the tag to the managed network device. In an example, the network management system engine determines a normalized name for the application based on a name provided by an application intelligence source. In an example, the network management system engine determines an application UUID for the application and determines the application UUID based on the normalized application name.

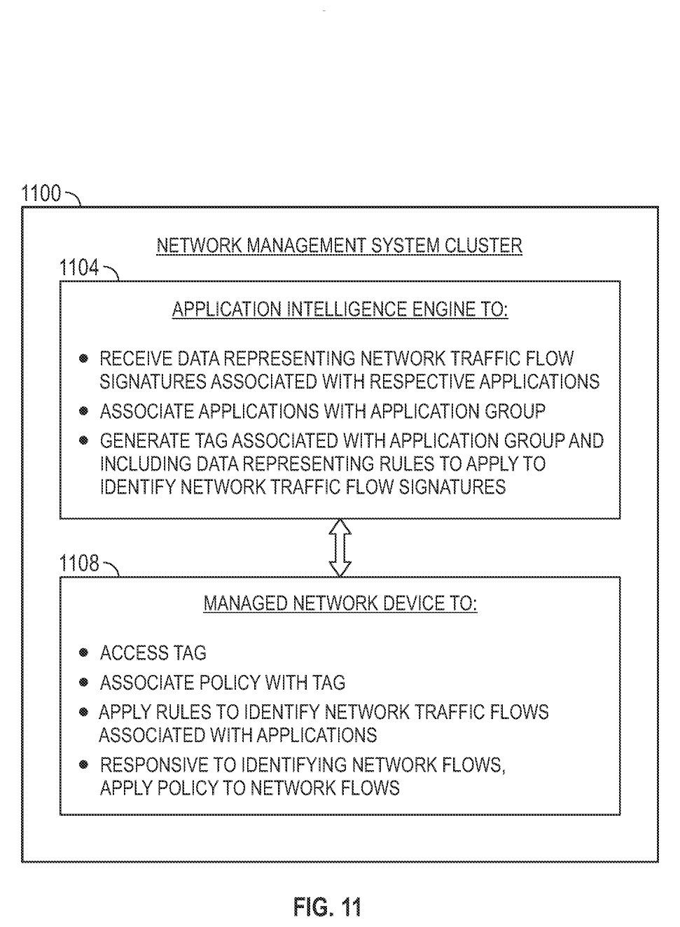

Referring to FIG. 11, in accordance with example implementations, a network management system cluster 1100 includes an application intelligence engine 1104 and a managed network device 1108. The application intelligence engine 1104 receives data representing network traffic flow signatures that are associated with respective applications.

In an example, the network management system cluster 1100 provides one or multiple NMS services that may be used to visualize, analyze, log, collect, query and/or monitor network telemetry and metrics that are reported by managed network devices. In another example, the network management system cluster 1100 identifies potential or actual network device failure issues based on network telemetry metric values. In another example, the network management system cluster 1100 identifies potential or actual network performance issues based on network telemetry and metric values. In another example, the network management system cluster 1100 oversees remedial actions to correct network issues. In another example, the network management cluster 1100 provides firmware upgrades for managed network devices.

In examples, the managed network device 1108 may be an access switch; a gateway; a router; a bridge; a component of a Gen-Z or CXL network; or a ToR switch. In an example, a network traffic flow signature is a collection of network traffic flow attributes associated with a network traffic flow, corresponds to a particular application and distinguishes the network traffic flow from a network traffic flow corresponding to another application.

In an example, the application intelligence engine 1104 receives the data representing the network traffic flow signatures from multiple application intelligence sources. The application intelligence engine 1104 associates the applications with an application group. In an example, the application group is a default collection of applications established by the application intelligence engine. In another example, the application group includes a collection of applications identified through user-selectable options. In another example, an application group includes a collection of applications that share a characteristic in common. In an example, an application group includes a collection of applications that have a geographical location in common. In another example, an application group includes a collection of applications that are considered to be trustworthy. In another example, an application includes a collection of applications that comply with a particular standard.

The application intelligence engine 1104 generates a tag that is associated with the application group. The tag includes data representing rules to apply to identify the network traffic flow signatures. In an example, the tag is a group application tag. In an example, a network traffic flow signature is a collection of network traffic flow attributes used to identify an application. In an example, the tag further includes metadata representing one or multiple network traffic flow attributes used to identify a network traffic flow signature. In an example, the tag includes a UUID identifying the application group.

The managed network device 1108 accesses the tag and associates a policy with the tag. The managed network device 1108 applies the rules to identify network traffic flows that are associated with the applications. In an example, the managed network device 1108 receives the tag from a distribution service associated with the network management system cluster. In an example, the policy is a security policy. In another example, the policy is a QoS policy. In another example, the policy is a routing policy. In an example, the managed network device 1108 uses a TCAM to apply the rules.

The managed network device 1108, responsive to identifying the network traffic flows, applies the policy to the network traffic flows. In an example, the policy is a security policy, and the managed network device 1108 selectively drops packets according to the security policy. In another example, the policy is a QoS policy, and the managed network device 1108 selectively applies QoS treatments to the network traffic flows. In another example, the policy is a routing policy, and the managed network device 1108 selectively generates IP forwarding addresses for the network traffic flows.

In accordance with example implementations, the application intelligence data is received from a plurality of application intelligence sources. Generating the tag includes including, in the tag, data representing access control expressions applied by the network device and corresponding to the rules. Among the potential advantages, managed network devices are quickly and efficiently updated with new application intelligence.

In accordance with example implementations, including the data representing the access control expressions includes including data representing address masks and network layer attributes of the network flows associated with the applications. Among the potential advantages, managed network devices are quickly and efficiently updated with new application intelligence.

In accordance with example implementations, the application intelligence data further represents a security intelligence attribute of the given application. Associating the applications with the application group includes determining, by the network management system, to associate the given application with the application group responsive to a determination that the security intelligence attribute is associated with the application group. Among the potential advantages, managed network devices are quickly and efficiently updated with new application intelligence.

In accordance with example implementations, the security intelligence attributes indicate at least one of a reputation of the given application, a compliance of the application with a predefined standard, or a geographical location of the application. Among the potential advantages, managed network devices are quickly and efficiently updated with new application intelligence.

In accordance with example implementations, receiving the application intelligence data includes receiving, from a first application source, data representing a first name for a given application. Associating the applications with the application group includes mapping the first name to a normalized name for the given application. The normalized name is generated by the application intelligence engine. Associating the applications with the application group further includes responsive to mapping the first name to the normalized name, determining that the given application is associated with the application group. Among the potential advantages, managed network devices are quickly and efficiently updated with new application intelligence.

In accordance with example implementations, associating the applications with the application group further includes mapping the normalized name to a unique identifier for the given application; and responsive to mapping the normalized name to the unique identifier, determining that the given application is associated with the application group. Among the potential advantages, managed network devices are quickly and efficiently updated with new application intelligence.

In accordance with example implementations, receiving the application intelligence data further includes receiving, from the first application intelligence source, data representing a first network flow signature of the given application and receiving, from a second application intelligence source, data representing a second network flow signature of the given application. Generating the tag includes incorporating the first network flow signature and the second network flow signature in the rules. Among the potential advantages, managed network devices are quickly and efficiently updated with new application intelligence.

In accordance with example implementations, receiving the application intelligence data further includes receiving, from the first application intelligence source, data representing a first vendor application identifier for a given application. Receiving the application intelligence data further includes receiving, from a second application intelligence source, data representing a second vendor application identifier for the given application. Generating the tag includes including data in the tag representing the first vendor application identifier and the second vendor application identifier. Among the potential advantages, managed network devices are quickly and efficiently updated with new application intelligence.

In accordance with example implementations, data is received from a user interface defining an application membership of the group. Among the potential advantages, managed network devices are quickly and efficiently updated with new application intelligence.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms "a," "an," and "the" are intended to include the plural forms as well, unless the context clearly indicates otherwise. The term "plurality," as used herein, is defined as two or more than two. The term "another," as used herein, is defined as at least a second or more. The term "connected," as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term "and/or" as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term "includes" means includes but not limited to, the term "including" means including but not limited to. The term "based on" means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
receiving, by an application intelligence engine, application intelligence data representing network traffic flow signatures associated with respective applications;
associating, by the application intelligence engine, the applications with an application group;
generating, by the application intelligence engine, a tag associated with the application group and comprising data representing rules to apply to recognize the network traffic flow signatures; and
configuring, by the application intelligence engine, a managed network device to identify network traffic flows associated with the applications, wherein the configuring comprises providing the tag to the managed network device to cause the managed network device to apply the rules to identify the network traffic flows.

2. The method of claim 1, wherein:
receiving the application intelligence data comprises receiving the application intelligence data from a plurality of application intelligence sources; and
generating the tag comprises including, in the tag, data representing access control expressions applied by the network device and corresponding to the rules.

3. The method of claim 2, wherein including data representing the access control expressions comprises including data representing address masks and network layer attributes of the network flows associated with the applications.

4. The method of claim 1, wherein:
the application intelligence data further represents a security intelligence attribute of a given application of the applications; and
associating the applications with the application group comprises determining, by the network management system, to associate the given application with the application group responsive to a determination that the security intelligence attribute is associated with the application group.

5. The method of claim 4, wherein the security intelligence attribute indicates at least one of a reputation of the given application, a compliance of the application with a predefined standard, or a geographical location of the application.

6. The method of claim 1, wherein:
receiving the application intelligence data comprises receiving, from a first application intelligence source, data representing a first name for a given application of the applications; and
associating the applications with the application group comprises:
mapping the first name to a normalized name for the given application, wherein the normalized name is generated by the application intelligence engine; and
responsive to mapping the first name to the normalized name, determining that the given application is associated with the application group.

7. The method of claim 6, wherein associating the applications with the application group further comprises:
mapping the normalized name to a unique identifier for the given application; and
responsive to mapping the normalized name to the unique identifier, determining that the given application is associated with the application group.

8. The method of claim 1, wherein:
receiving the application intelligence data further comprises receiving, from a first application intelligence source, data representing a first network flow signature of the given application and receiving, from a second application intelligence source other than the first application intelligence source, data representing a second network flow signature of the given application; and
generating the tag comprises, incorporating the first network flow signature and the second network flow signature in the rules.

9. The method of claim 1, wherein:
receiving the application intelligence data further comprises:
receiving, from the first application intelligence source, data representing a first vendor application identifier for a given application of the applications; and
receiving, from a second application intelligence source other than the first application intelligence source, data representing a second vendor application identifier for the given application; and
generating the tag comprises including data in the tag representing the first vendor application identifier and the second vendor application identifier.

10. The method of claim 1, further comprising receiving, from a user interface, data defining an application membership of the group.

11. A non-transitory storage medium that stores hardware processor-readable instructions that, when executed by a hardware processor, cause a network management system engine to:
receive, from a plurality of application intelligence sources, data representing network traffic flow signatures associated with an application;
generate a tag associated with the application and comprising data representing rules to apply to identify the network traffic flow signatures; and
provide the tag to a managed network device to cause the network device to apply a policy to network traffic flows associated with the application.

12. The storage medium of claim 11, wherein the instructions, when executed by the hardware processor, further cause the network management system engine to include, in the tag, data representing identifiers assigned by the application intelligence sources to the application.

13. The storage medium of claim 12, wherein the instructions, when executed by the hardware processor, further cause the network management system engine to determine a unique identifier for the application and include, in the tag, data representing the unique identifier.

14. The storage medium of claim 12, wherein the instructions, when executed by the hardware processor, further cause the network management system engine to include, in the tag, data representing, for a given rule of the rules, an Internet Protocol (IP) address mask and a network traffic parameter.

15. The storage medium of claim 12, wherein:
the network flow signatures are associated with a plurality of characteristics;
the managed network device is incapable of recognizing a given characteristic of the plurality of characteristics; and
the instructions, when executed by the hardware processor, further cause the network management system engine to:
receive a telemetry feed from the managed network device, wherein the telemetry feed indicates recognition of the application;
recognize the given characteristic from the telemetry feed; and
enrich the telemetry feed to provide an enriched telemetry feed representing recognition of the given characteristic.

16. A network management system cluster comprising:
an application intelligence engine to:
receive data representing network traffic flow signatures associated with respective applications;
associate the applications with an application group; and
generate a tag associated with the application group, wherein the tag comprises data representing rules to apply to identify the network traffic flow signatures; and
a managed network device to:
access the tag;
associate a policy with the tag;
apply the rules to identify network traffic flows associated with the applications; and
responsive to identifying the network traffic flows, apply the policy to the network traffic flows.

17. The network management system cluster of claim 16, wherein:
the policy comprises a security policy; and
the managed network device to apply the rules to identify a given network traffic flow of the network traffic flows, and determine based on the security policy, whether to permit or deny the given network traffic flow.

18. The network management system cluster of claim 16, wherein:
the policy comprises a routing policy; and
the managed network device to apply the rules to identify a given network traffic flow of the network traffic flows, and determine based on the routing policy, a forwarding Internet Protocol (IP) address for the given network traffic flow.

19. The network management system cluster of claim 16, wherein:
the policy comprises a quality of service (QoS) policy; and
the managed network device to apply the rules to identify a given network traffic flow of the network traffic flows, and determine based on the QoS, a QoS policer to process the given network traffic flow.

20. The network management system cluster of claim 16, wherein the managed network device comprises:
a ternary content addressable (TCAM) memory; and
a tag agent to program the TCAM memory based on the rules and the policy.
